(19) United States
(12) Patent Application Publication
(10) Pub. No.: US 2026/0200701 A1
(43) Pub. Date: Jul. 16, 2026

(54) WIRE ROPE FOR ELEVATOR, AND METHOD FOR REPAIRING ELEVATOR

(71) Applicant: Mitsubishi Electric Building Solutions Corporation, Tokyo (JP)

(72) Inventors: Masahiko HIDA, Tokyo (JP); Haruki TAKAOKA, Tokyo (JP); Junya YASUTOMI, Tokyo (JP)

(73) Assignee: Mitsubishi Electric Building Solutions Corporation, Tokyo (JP)

(21) Appl. No.: 19/135,820

(22) PCT Filed: Dec. 27, 2022
(86) PCT No.: PCT/JP2022/048380

§ 371 Date: Jun. 5, 2025

(51) Int. Cl. B66B 7/06; D07B 1/06

(52) U.S. Cl. CPC B66B 7/06; D07B 1/068; D07B 1/0686; D07B 2501/2007

(57) ABSTRACT

In a wire rope for an elevator, each side strand includes: a core wire; and at least one wire layer arranged around an outer periphery of the core wire. The number of the at least one wire layer is two or less. The at least one wire layer includes an outer layer being in contact with an outer periphery of a rope core. The outer layer includes a plurality of outer wires. A ratio of a sectional area of the plurality of outer wires included in each of the strands to a total sectional area of each of the strands is 60% or less. The rope core includes: a central steel wire; and a core outer-peripheral layer arranged around an outer periphery of the central steel wire.

### TECHNICAL FIELD

This disclosure relates to a wire rope for an elevator and a method of renovating an elevator.

### BACKGROUND ART

A related-art wire rope for an elevator includes a plurality of side strands made of steel and arranged around an outer periphery of a core. A plurality of auxiliary strands made of steel are arranged around an outer periphery of a layer formed of the plurality of side strands (see, for example, Patent Literature 1).

### CITATION LIST

### Patent Literature

[PTL 1] JP 2014-237908 A

### SUMMARY OF INVENTION

### Technical Problem

The related-art wire rope for an elevator, which is described in Patent Literature 1, additionally includes the plurality of auxiliary strands to increase a steel wire packing density so as to achieve an extended lifetime and increased strength. Thus, unit mass of the related-art wire rope for an elevator is different from those of other wire ropes. Thus, when the related-art wire rope is to be replaced, it is difficult to replace the wire rope with another wire rope. It has been required that a wire rope having the same sectional construction be prepared in advance. Further, outer wires in each of the auxiliary strands are formed of profile wires. Thus, a process of shaping each of the outer wires into a profile wire is required, and hence a manufacturing process is complicated.

This disclosure has been made to solve the problems described above, and has an object to provide a wire rope for an elevator and a method of renovating an elevator, which allow interchangeability with other wire ropes, each including steel wires at an increased packing density, to be ensured while preventing a manufacturing process from becoming complicated.

### Solution to Problem

According to one embodiment of this disclosure, there is provided a wire rope for an elevator, including: a rope core; and a plurality of side strands made of steel and arranged around an outer periphery of the rope core. Each of the side strands includes: a core wire; and at least one wire layer arranged around an outer periphery of the core wire. The number of the at least one wire layer is two or less. The at least one wire layer includes an outer layer being in contact with the outer periphery of the rope core. The outer layer includes a plurality of outer wires. A ratio of a sectional area of the plurality of outer wires included in each of the side strands to a total sectional area of each of the side strands is 60% or less. The rope core includes: a central steel wire arranged in a center of the rope core; and a core outer-peripheral layer arranged around an outer periphery of the central steel wire.

According to one embodiment of this disclosure, there is provided a method of renovating an elevator, including a step of replacing an existing wire rope for an elevator with a new wire rope for an elevator. The existing wire rope for an elevator and the new wire rope for an elevator each include: a rope core; and a plurality of side strands made of steel and arranged around an outer periphery of the rope core. The side strands in the existing wire rope for an elevator and the side strands in the new wire rope for an elevator each include a plurality of element wires. The plurality of element wires include a plurality of outer wires forming an outer layer being in contact with the rope core. The number of the outer wires in each of the side strands of the new wire rope for an elevator is larger than the number of the outer wires in each of the side strands of the existing wire rope for an elevator. An occupancy ratio of the plurality of outer wires in cross section to each of the side strands of the new wire rope for an elevator is lower than an occupancy ratio of the plurality of outer wires in cross section to each of the side strands of the existing wire rope for an elevator. Tensile strength of each of the element wires in each of the side strands of the new wire rope for an elevator except for the plurality of outer wires is higher than tensile strength of each of the element wires in each of the side strands of the existing wire rope for an elevator except for the plurality of outer wires. The rope core in the new wire rope for an elevator includes: a central steel wire; and a core outer-peripheral layer arranged around an outer periphery of the central steel wire.

### Advantageous Effects of Invention

According to this disclosure, interchangeability with other wire ropes, each including steel wires at an increased packing density, can be ensured while preventing a manufacturing process from becoming complicated.

### BRIEF DESCRIPTION OF DRAWINGS

FIG. 1 is a schematic configuration view for illustrating an elevator according to a first embodiment.

FIG. 2 is a sectional view of a main rope of FIG. 1.

FIG. 3 is a sectional view of a new main rope according to the first embodiment.

FIG. 4 is a sectional view of a new main rope according to a second embodiment.

FIG. 5 is a sectional view of a new main rope according to a third embodiment.

FIG. 6 is a sectional view of a new main rope according to a fourth embodiment.

FIG. 7 is a sectional view of a new main rope according to a fifth embodiment.

### DESCRIPTION OF EMBODIMENTS

Now, embodiments are described with reference to the drawings.

### First Embodiment

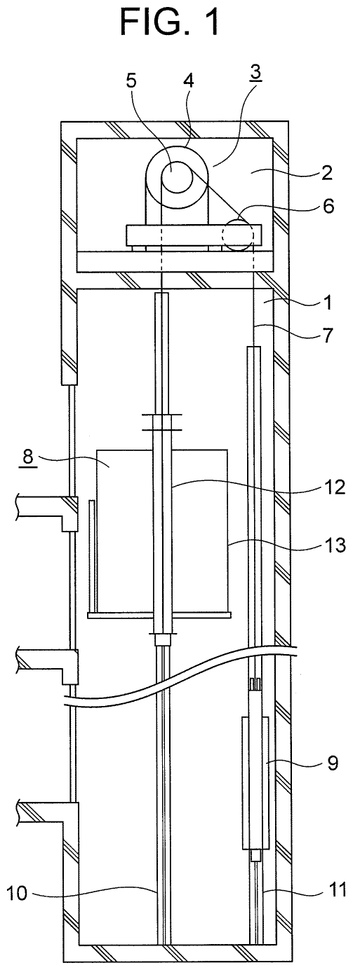

FIG. 1 is a schematic configuration view for illustrating an elevator according to a first embodiment, and the elevator before renovation is illustrated. In FIG. 1, a machine room 2 is provided in an upper part of a hoistway 1. A traction machine 3 and a deflector sheave 6 are installed in the machine room 2.

The traction machine 3 includes a traction machine main body 4 and a driving sheave 5. The traction machine main body 4 includes a traction machine motor (not shown) and a traction machine brake (not shown). The traction machine motor rotates the driving sheave 5. The traction machine brake holds the driving sheave 5 in a stationary state. Further, the traction machine brake brakes rotation of the driving sheave 5.

A plurality of existing main ropes 7 are wound around the driving sheave 5 and the deflector sheave 6. Each of the main ropes 7 is an existing wire rope for an elevator. In FIG. 1, only one main rope 7 is illustrated.

A car 8 and a counterweight 9 are suspended by the plurality of main ropes 7 in the hoistway 1. Further, the car 8 and the counterweight 9 are vertically moved in the hoistway 1 through rotation of the driving sheave 5.

In the hoistway 1, a pair of car guide rails 10 and a pair of counterweight guide rails 11 are installed. In FIG. 1, only one of the car guide rails 10 and one of the counterweight guide rails 11 are illustrated.

The pair of car guide rails 10 are configured to guide vertical movement of the car 8. The pair of counterweight guide rails 11 are configured to guide vertical movement of the counterweight 9.

The car 8 includes a car frame 12 and a cage 13. The plurality of main ropes 7 are connected to the car frame 12. The cage 13 is supported in the car frame 12.

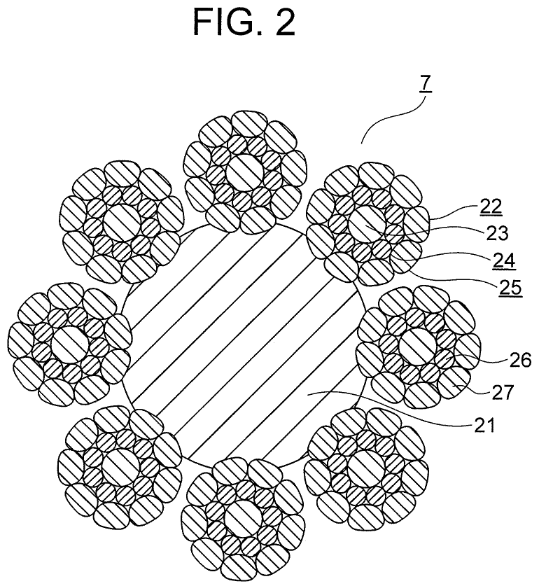

FIG. 2 is a sectional view of the main rope 7 of FIG. 1, taken orthogonally to a longitudinal direction of the main rope 7. The existing main rope 7 has an 8×P·S(19) Seale type sectional construction. In European Norm/European Standard (EN standard), 8×P·S(19) corresponds to 8×K19S.

The main rope 7 includes a rope core 21 and a plurality of side strands 22 made of steel. The rope core 21 is formed of a plurality of natural fibers. The number of side strands 22 is eight.

The plurality of side strands 22 are arranged around an outer periphery of the rope core 21. Further, the plurality of side strands 22 are twisted around the outer periphery of the rope core 21.

Each of the side strands 22 includes a core wire 23, an inner layer 24, and an outer layer 25. The inner layer 24 is arranged around an outer periphery of the core wire 23. The outer layer 25 is arranged around an outer periphery of the inner layer 24.

The inner layer 24 includes a plurality of inner wires 26. The plurality of inner wires 26 are twisted around the outer periphery of the core wire 23. In this example, the number of inner wires 26 is nine.

The outer layer 25 includes a plurality of outer wires 27. The plurality of outer wires 27 are twisted around the outer periphery of the inner layer 24. In this example, the number of outer wires 27 is nine, which is the same as the number of inner wires 26.

An outer shape of a cross section of each of the side strands 22 is made closer to a circle by performing a shaping process at a time of manufacture of each of the side strands 22. The shaping process is a process of compressing each of the side strands 22 from its radially outer side with use of a die.

As a result, a breaking force of the main rope 7 is improved by about 10% as compared to a rope without a shaping process on each of the side strands 22, that is, a rope having the 8×S(19 ) Seale type sectional construction. The breaking force of the main rope 7 is tensile strength of the main rope 7 as a whole. Hereinafter, the rope having the 8×S(19 ) Seale type sectional construction is referred to as “related-art rope”.

A method of renovating an elevator according to the first embodiment includes a step of replacing the plurality of existing main ropes 7 with a plurality of new main ropes. The new main ropes are new wire ropes for an elevator.

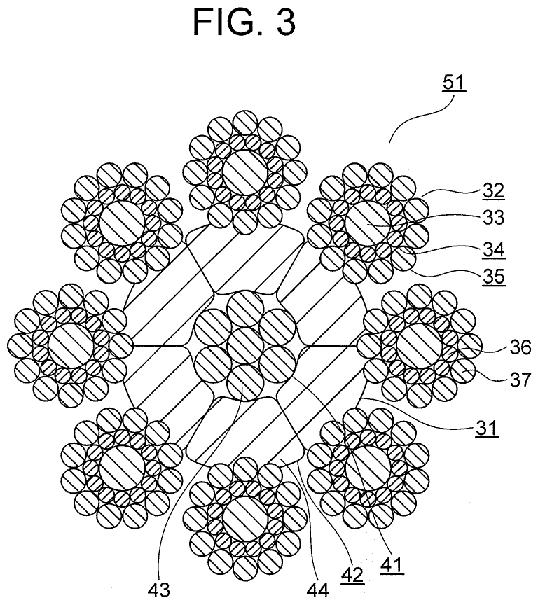

FIG. 3 is a sectional view of a new main rope according to the first embodiment, taken orthogonally to a longitudinal direction of the main rope. The new main rope has an 8×S(25 ) Seale type sectional construction.

In FIG. 3, a diameter of a new main rope 51 is the Same as a diameter of the existing main rope 7. The new main rope 51 includes a rope core 31 and a plurality of side strands 32 made of steel.

The number of side strands 32 is eight. Specifically, the number of side strands 32 in the new main rope 51 is the same as the number of side strands 22 in the existing main rope 7.

The plurality of side strands 32 are arranged around an outer periphery of the rope core 31. Further, the plurality of side strands 32 are twisted around the outer periphery of the rope core 31. Each of the side strands 32 is not subjected to the shaping process.

The rope core 31 includes a core strand 41 made of steel as a central steel wire, and a core outer-peripheral layer 42. The core strand 41 is arranged in a center of the rope core 31. The core outer-peripheral layer 42 is arranged around an outer periphery of the core strand 41.

The core strand 41 includes a plurality of core strand element wires 43. The number of core strand element wires 43 is seven. Specifically, the core strand 41 is formed by twisting six core strand element wires 43 around an outer periphery of one core strand element wire 43.

The core outer-peripheral layer 42 includes a plurality of core rope strands 44 made of fibers. The plurality of core rope strands 44 are twisted around the outer periphery of the core strand 41. The number of core rope strands 44 is six.

As a material of the core rope strands 44, natural fibers may be used. However, it is desired that synthetic filament fibers be used. Specifically, it is desired that the core outer-peripheral layer 42 be formed of synthetic fibers. As the synthetic fibers, multifilament polyester fibers are particularly desirable in terms of mechanical properties and manufacturing cost.

Each of the side strands 32 includes a core wire 33 and at least one wire layer. The at least one wire layer is arranged around an outer periphery of the core wire 33. The number of the at least one wire layer is two or less. The number of wire layers in the first embodiment is two. Specifically, each of the side strands 32 in the first embodiment includes an inner layer 34 and an outer layer 35, each being an wire layer.

The outer layer 35 is positioned at an outermost periphery of each of the side strands 32, and is a layer being in contact with the outer periphery of the rope core 31. The inner layer 34 is a layer arranged between the core wire 33 and the outer layer 35.

The inner layer 34 includes a plurality of inner wires 36. The plurality of inner wires 36 are twisted around the outer periphery of the core wire 33. In this example, the number of inner wires 36 is twelve.

The outer layer 35 includes a plurality of outer wires 37. Specifically, the plurality of outer wires 37 form the outer layer 35. The plurality of outer wires 37 are twisted around an outer periphery of the inner layer 34.

The number of outer wires 37 in each of the side strands 32 of the new main rope 51 is larger than the number of outer wires 27 in each of the side strands 22 of the existing main rope 7 and is twelve or more. In this example, the number of outer wires 37 is the same as the number of inner wires 36 and is twelve. Thus, a sectional construction of each of the side strands 32 has a Seale type in which the number of inner wires 36 and the number of outer wires 37 are the same.

Further, an occupancy ratio of the plurality of outer wires 37 to each of the side strands 32 of the new main rope 51 in cross section is smaller than an occupancy ratio of the plurality of outer wires 27 to each of the side strands 22 of the existing main rope 7 in cross section.

More specifically, in the new main rope 51, a ratio of a total sectional area of all the outer wires 37 included in each of the side strands 32 to a total sectional area of each of the side strands 32 is 60% or less.

Further, tensile strength of each of the element wires in each of the side strands 32 of the new main rope 51 except for the plurality of outer wires 37 is higher than tensile strength of each of the element wires in each of the side strands 22 of the existing main rope 7 except for the plurality of outer wires 27. Specifically, tensile strength of the core wire 33 is higher than tensile strength of the core wire 23, and tensile strength of each of the inner wires 36 is higher than tensile strength of each of the inner wires 26.

Further, tensile strength of each of the outer wires 37 in each of the side strands 32 of the new main rope 51 is the same as tensile strength of each of the outer wires 27 in each of the side strands 22 of the existing main rope 7.

More specifically, in the new main rope 51, the tensile strength of each of the outer wires 37 is 1, 770 MPa class or less, for example, 1,570 N/mm² class or 1,620 N/mm² class.

Further, in the new main rope 51, the tensile strength of the core wire 33 and the tensile strength of each of the inner wires 36 are 2,000 MPa class or more, for example, 2,300 N/mm² class or 2,400 N/mm² class. As described above, the tensile strength of the core wire 33 and the tensile strength of each of the inner wires 36 are each about 1.5 times the tensile strength of each of the outer wires 37.

Further, tensile strength of the new main rope 51 is higher than tensile strength of the existing main rope 7. Further, unit mass, specifically, mass per unit length of the new main rope 51 is the same as unit mass of the existing main rope 7. Thus, with the renovating method according to the first embodiment, the existing traction machine 3 is used as a traction machine even after the renovation.

Here, in general, when unit mass of a main rope used after renovation is different from unit mass of a main rope used before the renovation by a certain amount or more, mass balance between a car side and a counterweight side changes after the renovation. Thus, a traction machine motor and a traction machine brake for an existing traction machine cannot be used. Further, traction loss may occur.

Thus, a main rope having unit mass different from unit mass of a main rope that has hitherto been used is used for an elevator to be newly installed. In terms of demand for main ropes, however, main ropes are fairly often used for rope replacement at a time of maintenance of existing elevators.

Further, it has always been required that the strength of a main rope be increased without an increase in rope diameter so that the main rope can be used for elevators with a wider variety of specifications. Examples of a method for increasing the strength of a main rope as described above include a method of using a main rope of one strength grade higher and a method of using six strands in place of eight strands.

For example, when a rope of type B with higher strength grade is used in place of a rope of type A, the strength can be increased to about 110%. Further, also when six strands are used in place of eight strands, the strength can be increased to about 110%. When these methods are both carried out, the strength can be increased to about 120%. As a result, not only improvement in use of a main rope for elevators with a wider variety of specifications but also a reduction in the number of ropes can be achieved. Thus, cost can be significantly reduced.

However, when tensile strength of element wires is simply increased so as to achieve a main rope with higher strength, hardness of the element wires is increased and the driving sheave being in contact with the main rope may be worn earlier. Further, a load on the main rope is increased. Thus, a contact surface pressure between the main rope and the driving sheave is increased, and hence the main rope may be damaged earlier.

Examples of the method of increasing the rope strength also include a method of using high-strength fibers as a material of a rope core. However, the high-strength fibers are generally expensive. Hence, the main rope as a whole becomes expensive.

Meanwhile, with the method of renovating an elevator according to the first embodiment, a larger number of outer wires 37 are used so as to reduce a ratio of a sectional area of the plurality of outer wires 37 in each of the side strands 32 of the new main rope 51. Further, the tensile strength of each of the element wires in each of the side strands 32 of the new main rope 51 except for the plurality of outer wires 37 is increased.

Further, the tensile strength of each of the outer wires 37 in each of the side strands 32 of the new main rope 51 is the same as the tensile strength of each of the outer wires 27 in each of the side strands 22 of the existing main rope 7. Specifically, hardness of each of the outer wires 37 in the new main rope 51 is the same as hardness of each of the outer wires 27 in the existing main rope 7.

Thus, an increase in contact surface pressure between the new main rope 51 and the driving sheave 5 is suppressed. As a result, early damage to the new main rope 51 and early wear of the driving sheave 5 can be suppressed.

Further, the amount of steel wires in each of the side strands 32 of 8×S(25 ) type is less than the amount of steel wires in each of the side strands 22 of 8×P·S(19) type. In the new main rope 51, however, the rope core 31 includes the core strand 41. Thus, the unit mass of the new main rope 51 can easily be increased to be closer to the unit mass of the existing main rope 7.

As a result, interchangeability with the existing main rope 7 can be ensured without a shaping process on each of the side strands 32 in the new main rope 51. Specifically, the interchangeability with the existing main rope 7 including steel wires at an increased packing density can be enhanced while preventing a manufacturing process from becoming complicated.

Further, the ensured interchangeability between the exiting main rope 7 and the new main rope 51 allows the existing traction machine 3 to be used even after the renovation. As a result, renovation work can more easily be performed.

Further, the new main rope 51 according to the first embodiment allows the degree of wear of the driving sheave 5 to be equal to that before the renovation while achieving higher strength than that of the related-art ropes. Thus, a rope lifetime equal to that before the renovation can be achieved.

More specifically, a ratio of a total sectional area of all the outer wires 27 in each of the side strands 22 of a common related-art rope is about 70%. Further, in general, an upper limit of tensile strength of a steel wire used for an elevator, which can be achieved without an increase in cost, is 2,500 N/mm² class.

Meanwhile, in the first embodiment, a ratio of a sectional area of all the outer wires 37 included in each of the outer-peripheral stands 32 is set to 60% or less. As a result, in the new main rope 51, the tensile strength of each of the core wires 33 and the tensile strength of each of the inner wires 36 are each set to be about 1.5 times the tensile strength before the renovation while the tensile strength of each of the outer wires 37 is set equal to the tensile strength before the renovation. In this manner, a higher breaking force is achieved.

For example, strength of each of the side strands in a related-art rope is defined as 100 and is compared with strength of each of the side strands 32 in the new main rope 51. Then, the strength is obtained as follows.
Related-art rope: 100×0.7+100×0.3=100
New main rope 51: 100×0.6+150×0.4=120

Further, the core strand 41 included in the rope core 31 achieves a further higher breaking force of the new main rope 51. As described above, the number of new main ropes 51 can be reduced by increasing the strength of the new main rope 51.

Further, the new main rope 51 includes the side strands 32 each having a simple construction, and hence is easy to manufacture. Accordingly, manufacturing cost can be reduced.

Further, the number of outer wires 37 in each of the side strands 32 of the new main rope 51 is twelve or more. Thus, the ratio of the sectional area of the plurality of outer wires 27 can easily be set to about 60% or less. Further, the contact surface pressure between the new main rope 51 and the driving sheave 5 can be reduced.

Further, in each of the side strands 32, the inner layer 24 is arranged between the central element wire 33 and the outer layer 35. Thus, the strength of each of the side strands 32 can be increased while a diameter of the core wire 33 is prevented from being increased.

Further, in the new main rope 51, the tensile strength of each of the outer wires 37 is 1,770 MPa class or less, and the tensile strength of the core wire 33 and the tensile strength of each of the inner wires 36 are each 2,000 MPa class or more. Thus, the breaking force of the main rope 51 can more reliably be increased.

Further, in the new main rope 51, each of the side strands 32 has a Seale type sectional construction. Thus, the new main rope 51 can easily be manufactured by the same manufacturing device as a manufacturing device for common related-art ropes.

Further, a related-art rope without including the core strand 41 in the rope core 31 can also easily be manufactured by the same manufacturing device.

Further, in the new main rope 51, the number of side strands 32 is set to six or more. As a result, a sectional shape of the main rope 51 can be stabilized.

Further, the extension of a lifetime of the new main rope 51 as a whole can be achieved by using synthetic fibers as a material of the core outer-peripheral layer 42.

The extended lifetime of the new main rope 51 can achieve the extension of a rope replacement cycle, and can reduce life cycle cost.

### Second Embodiment

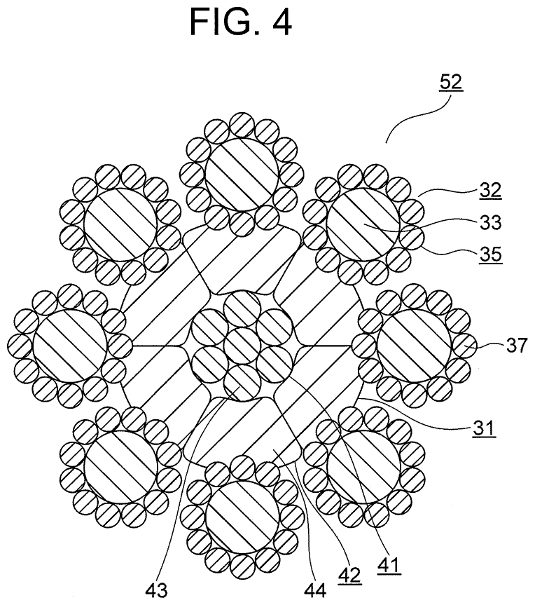

Next, FIG. 4 is a sectional view of a new main rope according to a second embodiment, taken orthogonally to a longitudinal direction of the main rope.

In a new main rope 52 according to the second embodiment, at least one wire layer in each side strand 32 is only an outer layer 35, and an inner layer 34 is not provided. Specifically, each of the side strands 32 in the new main rope 52 according to the second embodiment has a single-lay pattern sectional construction. Outer wires 37 are twisted around an outer periphery of a core wire 33.

Also in this case, tensile strength of each of the outer wires 37 is 1,770 MPa class or less. Further, tensile strength of the core wire 33 is 2,000 MPa class or more.

Other configurations and a renovation method according to the second embodiment are the same as those according to the first embodiment. The new main rope 52 is a new wire rope for an elevator.

In such a new main rope 52, the core wire 33 in each of the side strands 32 has a larger diameter. However, when the main rope 52 has a small diameter, the sectional construction according to the second embodiment is also applicable. In this manner, the manufacture of the side strands 32 can be facilitated.

### Third Embodiment

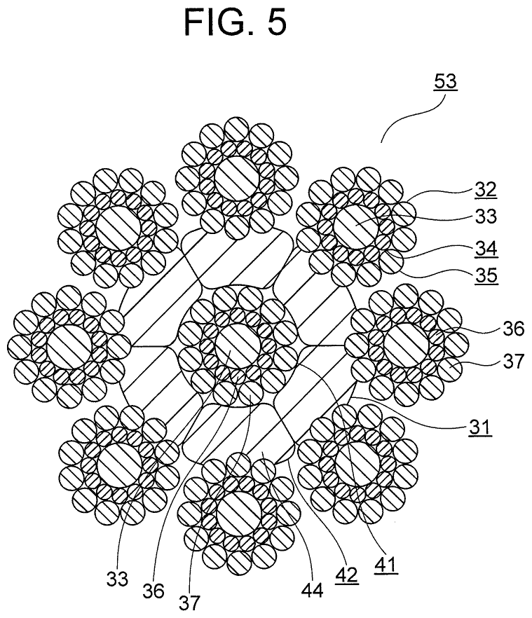

Next, FIG. 5 is a sectional view of a new main rope according to a third embodiment, taken orthogonally to a longitudinal direction of the main rope.

In a new main rope 53 according to the third embodiment, the same strand as an side strand 32 is used as a core strand 41. Specifically, a sectional construction of the core strand 41 is the same as a sectional construction of each of the side strands 32. Further, a diameter of the core strand 41 is the same as a diameter of each of the side strands 32.

Other configurations and a renovation method according to the third embodiment are the same as those according to the first embodiment. The new main rope 53 is a new wire rope for an elevator.

In such a new main rope 53, the same strand as the side strand 32 is used as the core strand 41. Thus, manufacturing cost can be reduced.

Further, the new main rope 53 described above is suitable for replacement of an existing main rope of, for example, 6×P·S(19) type. Specifically, it is easy to set unit mass of the new main rope 53 according to the third embodiment equal to unit mass of the existing main rope of 6×P·S(19) type. The 6×P·S(19) type has a Seale type including six side strands, each having been subjected to a shaping process and including nineteen element wires.

### Fourth Embodiment

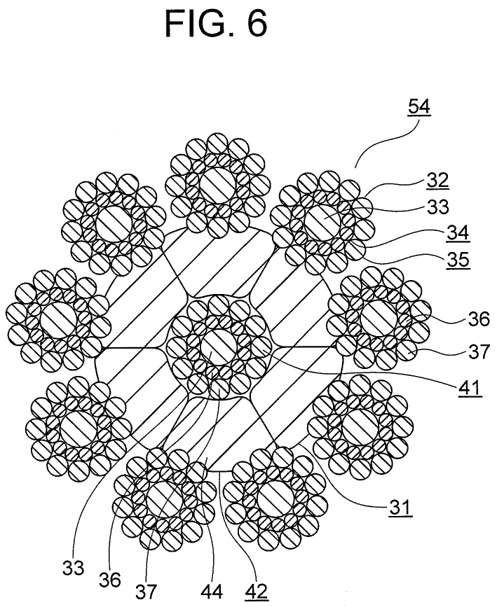

Next, FIG. 6 is a sectional view of a new main rope according to a fourth embodiment, taken orthogonally to a longitudinal direction of the main rope.

In a new main rope 54 according to the fourth embodiment, the number of side strands 32 is nine. Further, the same strand as the side strand 32 is used as a core strand 41. Specifically, a sectional construction of the core strand 41 is the same as a sectional construction of each of the side strands 32. Further, a diameter of the core strand 41 is the same as a diameter of each of the side strands 32.

Other configurations and a renovation method according to the fourth embodiment are the same as those according to the first embodiment. The new main rope 54 is a new wire rope for an elevator.

In such a new main rope 54, the same strand as the side strand 32 is used as the core strand 41. Thus, manufacturing cost can be reduced.

Further, the new main rope 54 described above is suitable for replacement of an existing main rope of, for example, 6×S(19) type. Specifically, it is easy to set unit mass of the new main rope 54 according to the fourth embodiment equal to unit mass of the existing main rope of 6×S(19 ) type.

The 6×S(19 ) type has a Seale type including six side strands, each having not been subjected to a shaping process and including nineteen element wires. Also in the 6×S(19 ) type, a steel wire packing density is increased as compared to that in the 8×S(19 ) type.

### Fifth Embodiment

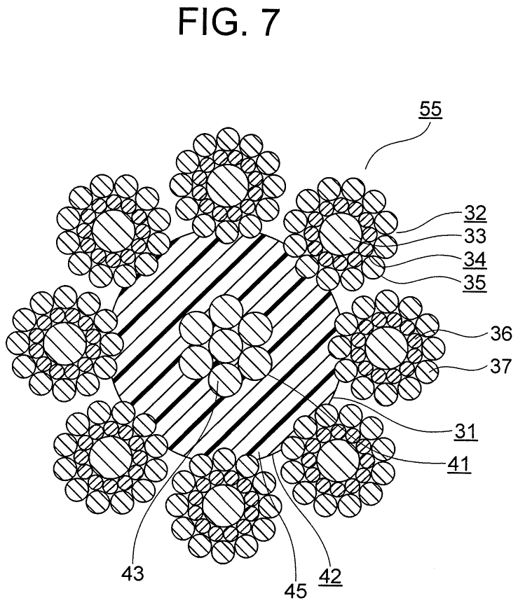

Next, FIG. 7 is a sectional view of a new main rope according to a fourth embodiment, taken orthogonally to a longitudinal direction of the main rope.

In a new main rope 5 according to the fifth embodiment, a core outer-peripheral layer 42 is formed of a core coating body 45 made of a resin. Specifically, the core outer-peripheral layer 42 is made of a resin, and a core strand 41 is coated with the core coating body 45.

Polyethylene, polypropylene or the like is desirable as a material of the core coating body 45 in terms of wear resistance and a low friction property.

Other configurations and a renovation method according to the fifth embodiment are the same as those according to the first embodiment. The new main rope 55 is a new wire rope for an elevator.

In such a new main rope 55, the core coating body 45 made of a resin is provided between the core strand 41 and a plurality of side strands 32. Thus, wear of the core strand 41 and wear of each of the side strands 32 can be suppressed, and hence the extension of the lifetime of the main rope 55 can be achieved.

A central steel wire may be a single wire in place of a strand.

Further, with the method of renovating an elevator, the existing driving sheave 5 may be replaced by a new driving sheave, while the existing traction machine main body 4 is used even after the renovation.

Further, the entire layout of elevator is not limited to the layout illustrated in FIG. 1. For example, a 2:1 roping method may be used as a roping method.

Further, the elevator may be, for example, a machine room-less elevator, a double-deck elevator, and a one-shaft multi-car system elevator apparatus. The one-shaft multi-car system is a system in which an upper car and a lower car arranged directly below the upper car are vertically moved in the common hoistway independently.

Further, the wire rope for an elevator may be a wire rope for an elevator other than a main rope, for example, a compensating rope or a governor rope.

### REFERENCE SIGNS LIST

3 existing traction machine, 7 existing main rope (existing wire rope for elevator), 8 car, 21,31 rope core, 22, 32 side strand, 23, 33 core wire, 24, 34 inner layer, 25, 35 outer layer, 26,36 inner wire,: 27, 37 outer wire, 41 core strand (central steel wire), 42 core outer-peripheral layer, 51, 52, 53, 54, 55 new main rope (new wire rope for elevator)

1. A wire rope for an elevator, comprising:
a rope core; and
a plurality of side strands made of steel and arranged around an outer periphery of the rope core,
wherein each of the side strands includes:
a core wire; and
at least one wire layer arranged around an outer periphery of the core wire,
wherein the number of the at least one wire layer is two or less,
wherein the at least one wire layer includes an outer layer being in contact with the outer periphery of the rope core,
wherein the outer layer includes a plurality of outer wires,
wherein a ratio of a sectional area of the plurality of outer wires included in each of the side strands to a total sectional area of each of the side strands is 60% or less, and
wherein the rope core includes:
a central steel wire arranged in a center of the rope core; and
a core outer-peripheral layer arranged around an outer periphery of the central steel wire.

2. The wire rope for an elevator according to claim 1, wherein the number of the outer wires in each of the side strands is twelve or more.

3. The wire rope for an elevator according to claim 1,
wherein the at least one wire layer further includes an inner layer arranged between the core wire and the outer layer, and
wherein the inner layer includes a plurality of inner wires.

4. The wire rope for an elevator according to claim 3,
wherein tensile strength of each of the outer wires is 1,770 MPa class or less, and
wherein tensile strength of the core wire and tensile strength of each of the inner wires are each 2,000 MPa class or more.

5. The wire rope for an elevator according to claim 3, wherein a sectional construction of each of the side strands has a Seale type.

6. The wire rope for an elevator according to claim 1, wherein the at least one wire layer is only the outer layer.

7. The wire rope for an elevator according to claim 6,
wherein tensile strength of each of the outer wires is 1,770 MPa class or less, and
wherein tensile strength of the core wire is 2,000 MPa class or more.

8. The wire rope for an elevator according to claim 1, wherein the number of the side strands is six or more.

9. The wire rope for an elevator according to claim 1,
wherein the central steel wire is a core strand made of steel, and
wherein a sectional construction of the core strand is the same as a sectional construction of each of the side strands.

10. The wire rope for an elevator according to claim 1, wherein the core outer-peripheral layer is formed of synthetic fibers.

11. The wire rope for an elevator according to claim 1, wherein the core outer-peripheral layer is formed of a resin.

12. The wire rope for an elevator according to claim 1, wherein each of the side strands is free from a shaping process of compressing each of the side strands from a radially outer side.

13. A method of renovating an elevator, comprising a step of replacing an existing wire rope for an elevator with a new wire rope for an elevator,
wherein the existing wire rope for an elevator and the new wire rope for an elevator each include: a rope core; and a plurality of side strands made of steel and arranged around an outer periphery of the rope core,
wherein the side strands in the existing wire rope for an elevator and the side strands in the new wire rope for an elevator each include a plurality of element wires,
wherein the plurality of element wires include a plurality of outer wires forming an outer layer being in contact with the rope core,
wherein the number of the outer wires in each of the side strands of the new wire rope for an elevator is larger than the number of the outer wires in each of the side strands of the existing wire rope for an elevator,
wherein an occupancy ratio of the plurality of outer wires in cross section to each of the side strands of the new wire rope for an elevator is lower than an occupancy ratio of the plurality of outer wires in cross section to each of the side strands of the existing wire rope for an elevator,
wherein tensile strength of each of the element wires in each of the side strands of the new wire rope for an elevator except for the plurality of outer wires is higher than tensile strength of each of the element wires in each of the side strands of the existing wire rope for an elevator except for the plurality of outer wires, and
wherein the rope core in the new wire rope for an elevator includes: a central steel wire; and a core outer-peripheral layer arranged around an outer periphery of the central steel wire.

14. The method of renovating an elevator according to claim 13, wherein tensile strength of each of the outer wires in each of the side strands of the new wire rope for an elevator is the same as tensile strength of each of the outer wires in each of the side strands of the existing wire rope for an elevator.

15. The method of renovating an elevator according to claim 13, wherein each of the side strands in the new wire rope for an elevator is free from a shaping process of compressing each of the side strands from a radially outer side.

16. The method of renovating an elevator according to claim 13,
wherein the existing wire rope for an elevator and the new wire rope for an elevator are each a main rope for suspending a car, and
wherein an existing traction machine is used even after renovation.
